(19) United States
(12) Patent Application Publication
(10) Pub. No.: US 2022/0403571 A1
(43) Pub. Date: Dec. 22, 2022

(54) NONWOVEN FABRIC AND NONWOVEN FABRIC MANUFACTURING METHOD

(71) Applicant: FUJIFILM Corporation, Tokyo (JP)

(72) Inventors: Kenichi UMEMORI, Minami-ashigara-shi (JP); Shunichi YOSHIDA, Minami-ashigara-shi (JP)

(73) Assignee: FUJIFILM Corporation, Tokyo (JP)

(21) Appl. No.: 17/894,353

(22) Filed: Aug. 24, 2022

Related U.S. Application Data
(63) Continuation of application No. PCT/JP2021/005054, filed on Feb. 10, 2021.

(30) Foreign Application Priority Data
Feb. 25, 2020 (JP) 2020-029643

(51) Int. Cl. D04H 1/728; D04H 1/425; D01D 5/00; D01F 2/00

(52) U.S. Cl. CPC D04H 1/728; D04H 1/425; D01D 5/0038; D01F 2/00; D10B 2505/04; D10B 2201/20

(57) ABSTRACT

A nonwoven fabric manufacturing facility includes a fiber assembly manufacturing step and a heating and drawing step. In the fiber assembly manufacturing step, fibers formed using an electrospinning method are collected to form a fiber assembly. In the heating and drawing step, the fiber assembly is drawn to form nonwoven fabric in a state where the fiber assembly is heated to a melting point of the fibers. In the formed nonwoven fabric, an average pore diameter is 15 μm or more, a relative standard deviation of a pore diameter distribution is 0.1 or less, and an average fiber diameter of the fibers is 3 μm or less.

### CROSS-REFERENCE TO RELATED APPLICATIONS

This application is a Continuation of PCT International Application No. PCT/JP2021/005054 filed on 10 Feb. 2021, which claims priority under 35 U.S.0 § 119(a) to Japanese Patent Application No. 2020-029643 filed on 25 Feb. 2020. The above application is hereby expressly incorporated by reference, in its entirety, into the present application.

### BACKGROUND OF THE INVENTION

### 1. Field of the Invention

The present invention relates to nonwoven fabric and a nonwoven fabric manufacturing method.

### 2. Description of the Related Art

As nonwoven fabric for forming fibers, nonwoven fabrics described in JP2008-523951A (corresponding to US2006/135932A1), JP2015-143404A, and JP2014-083216A are known. Nonwoven fabrics have been actively developed in the field of various applications. Examples of prospective applications include a heat insulating member, a sound absorbing material, and a filter. In addition, the use of the nonwoven fabric as a medical scaffold material or a cell scaffold material. The nonwoven fabric is formed by blowing a solution in which a fiber material is dissolved in a solvent to a collector to form fibers and collecting the blown fibers.

### SUMMARY OF THE INVENTION

The nonwoven fabric exhibits excellent performance. For example, as the fiber diameter decreases, the void ratio is improved. In addition, as a relative standard deviation of a pore diameter distribution in the nonwoven fabric decreases, for example, in a case where the nonwoven fabric is used as a filter, stable performance can be exhibited. On the other hand, in a case where the nonwoven fabric is used as a filter, the pore diameter of the nonwoven fabric needs to be determined depending on the size of an object that is removed through the filter.

However, in the related art, it is difficult to obtain nonwoven fabric having a large pore diameter while suppressing the fiber diameter to be small and suppressing the relative standard deviation of a pore diameter distribution to be small. That is, in order to suppress the relative standard deviation of a pore diameter distribution, a method of heating a fiber assembly in which fibers are collected to remove a residual stress is known. In this case, fibers contract during heating. Therefore, the fiber diameter increases, and the pore diameter also decreases. In addition, in a case where the fiber assembly is drawn to increase the pore diameter, the relative standard deviation of the pore diameter distribution increases.

The present invention has been made in consideration of the above-described circumstances, and an object thereof is to provide: nonwoven fabric having a large pore diameter but having a small fiber diameter and a small relative standard deviation of a pore diameter distribution; and a nonwoven fabric manufacturing method capable of manufacturing the nonwoven fabric.

In order to achieve the object, according to an aspect of the present invention, there is provided nonwoven fabric that is formed of fibers, in which an average pore diameter is 15 μm or more, a relative standard deviation of a pore diameter distribution is 0.1 or less, and an average fiber diameter of the fibers is 3 μm or less.

The fibers may be formed of a cellulose polymer.

In addition, in order to achieve the object, according to another aspect of the present invention, there is provided a nonwoven fabric manufacturing method in which nonwoven fabric is formed by blowing a solution in which a fiber material is dissolved in a solvent to a collector to form fibers and collecting the blown fibers, the nonwoven fabric manufacturing method comprising: a heating and drawing step of heating and drawing a fiber assembly formed by collecting the fibers, in which in the heating and drawing step, the fibers are drawn in a state where a temperature of the fibers is a melting point or higher.

A tension may be applied to the fiber assembly before the temperature of the fibers reaches the melting point, and the fiber assembly may be drawn by the tension after the temperature of the fibers reaches the melting point.

The fibers may be blown by applying a voltage between the solution and the collector.

The fibers may be formed of a cellulose polymer.

According to the aspect of the present invention, nonwoven fabric having a large pore diameter but having a small fiber diameter and a small relative standard deviation of a pore diameter distribution can be obtained.

### BRIEF DESCRIPTION OF THE DRAWINGS

FIG. 1 is a schematic perspective view showing a part of nonwoven fabric.

FIG. 2 is a schematic diagram showing a nonwoven fabric manufacturing facility.

### DESCRIPTION OF THE PREFERRED EMBODIMENTS

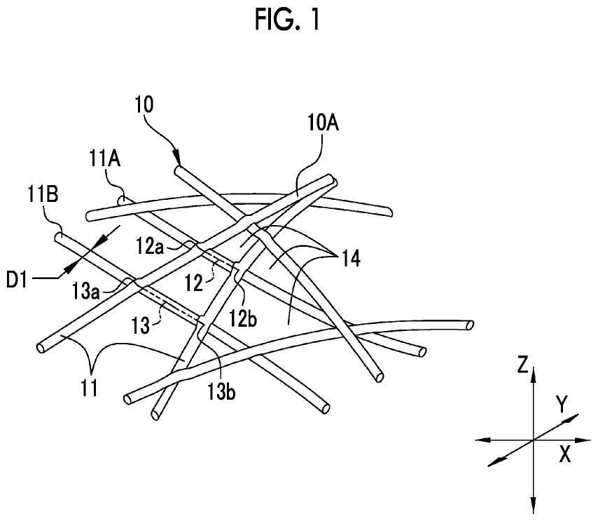

Nonwoven fabric 10 according to an embodiment of the present invention shown in FIG. 1 is formed of fibers 11. The fibers 11 are entangled with each other, in which portions where fibers overlap each other in a thickness direction and/or portions (contacts) in a plane direction (XY plane) of the nonwoven fabric 10 are present. At the contacts, fibers 11 that adhere to each other and fibers that do not adhere to each other are present. The nonwoven fabric 10 only has to include the fibers 11 and may include not only the fibers 11 but also other fibers formed of a different material.

For simplicity of the drawing, FIG. 1 shows only a part of one surface (hereinafter, first surface) 10A side in the thickness direction of the nonwoven fabric 10. Accordingly, the nonwoven fabric 10 has a structure in which a larger number of fibers 11 overlap each other on the lower side in the thickness direction. In addition, FIG. 1 shows a state where the first surface 10A is disposed along the XY plane, in which a Z-axis perpendicular to the XY plane is set as the thickness direction of the nonwoven fabric 10.

The fibers 11 are formed such that fiber diameters D1 are substantially uniform. An average (hereinafter, referred to as “average fiber diameter”) DF (the unit is μm) of the fiber diameters D1 is 3.00 μm or less and is preferably in a range of 0.10 μm or more and 3.00 μm or less. By adjusting the average fiber diameter DF to be 0.10 μm or more, desorption of a fiber segment is suppressed as compared to a case where the average fiber diameter is less than 0.10 μm. Suppressing the desorption of a fiber segment represents suppressing the desorption of a fiber segment from the nonwoven fabric 10, and suppressing the desorption of a fiber segment leads to excellent durability as the nonwoven fabric 10. By adjusting the average fiber diameter DF to be 3.00 μm or less, even in a case where the volume proportion (hereinafter, referred to as “void ratio”) of air in the nonwoven fabric 10 may be the same, the nonwoven fabric 10 is softer than that in a case where the average fiber diameter is more than 3.00 μm. By adjusting the average fiber diameter DF to be 3.00 μm or less, even in a case where the softness of the nonwoven fabric 10 is the same, the void ratio is more than that in a case where the average fiber diameter is more than 3.00 μm. As a result, sound absorbing performance and heat insulating performance are improved in a case where the nonwoven fabric 10 is used as a sound absorbing material or a heat insulating member, and the filtration throughput increases in a case where the nonwoven fabric 10 is used as a filter. The average fiber diameter DF is more preferably in a range of 0.15 μm or more and 2.90 μm or less and still more preferably in a range of 0.20 μm or more and 2.80 μm or less. The average fiber diameter DF can be obtained by measuring fiber diameters of 100 fibers 11 from an image obtained using a scanning electron microscope and calculating the average value thereof

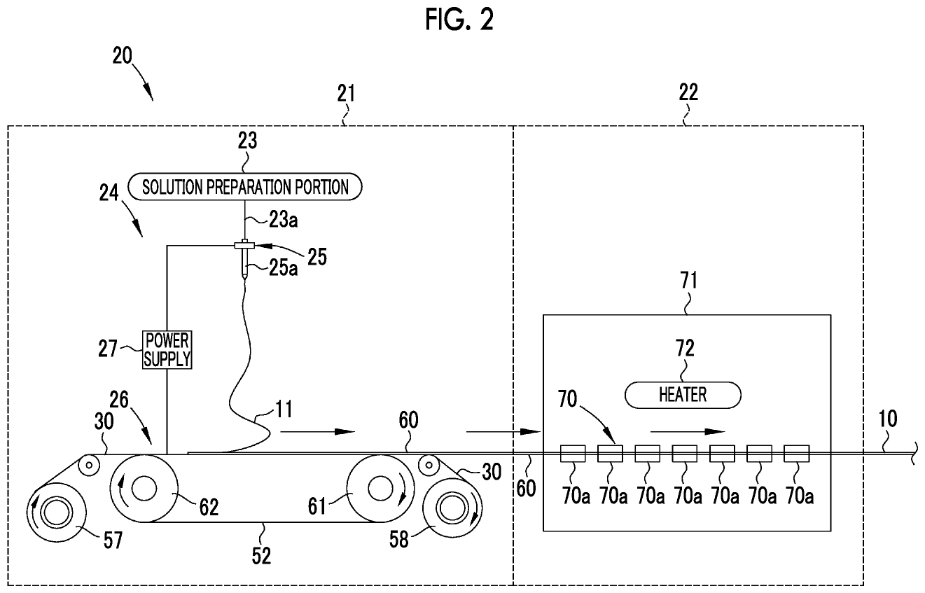

As described below, the nonwoven fabric 10 is formed through a heating and drawing step 22 (refer to FIG. 2) of heating and drawing a fiber assembly 60 (refer to FIG. 2) in which the fibers 11 are collected. By heating the fiber assembly 60 in the heating and drawing step 22, a residual stress (a force that is accumulated in the fibers 11 and bends the fibers 11 during the collection) is removed from the fiber assembly 60, and the fibers 11 are linearized (are approximated to a straight line from the bent state (the linearity is improved)). The nonwoven fabric 10 is linearized during this heating, and the alignment degree of the fibers 11 is 1.1 or more and 1.3 or less.

The alignment degree of the fibers 11 functions as an index representing the aligning properties of the fibers 11 (the degree to which longitudinal directions thereof are aligned). As the alignment degree decreases, the directions of the fibers 11 are not aligned (the aligning properties are weak), and as the alignment degree increases, the directions of the fibers 11 are not aligned (the aligning properties are strong). Specifically, in a case where the alignment degree is 1.0, the fibers 11 are not substantially aligned. In a case where the alignment degree is 1.1 or more, the fibers 11 have aligning properties. In a case where the alignment degree is 1.2 or more, the fibers 11 have strong aligning properties. In the present invention, in a case where the alignment degree is 1.1 or more and 1.3 or less, the effects are exhibited. The alignment degree is preferably 1.15 or more and 1.25 or less and more preferably 1.2 or more and 1.25 or less. The alignment degree can be calculated using image analysis software (refer to “http://ps1.fp.a.u-tokyo.ac.jp/research02_04.html”) that is generally known.

This way, in the nonwoven fabric 10, the alignment degree of the fibers 11 is high. Accordingly, an average of inter-line angles of the fibers 11 is a value similar to 180 degrees. Here, it is preferable that the average of the inter-line angles is 178 degrees or more and 182 degrees or less.

The inter-line angle refers to an angle between a first line segment 12 and a second line segment 13 (angle of the second line segment 13 with respect to the first line segment 12), the first line segment 12 being a line segment that is obtained by connecting two adjacent contacts 12a and 12b among contacts of a first fiber 11A as one of the fibers 11 in the nonwoven fabric 10 and other fibers 11, and the second line segment 13 being a line segment that is obtained by connecting two adjacent contacts 13a and 13b among contacts of a second fiber 11B as one of the fibers 11 in the nonwoven fabric 10 and other fibers 11. In the nonwoven fabric 10, a plurality of line segments corresponding to the first line segment 12 and a plurality of line segments corresponding to the second line segment 13 are present, and of course, combinations of the line segments corresponding to the first line segment 12 and the line segments corresponding to the second line segment 13 are present. The average of the inter-line angles can be obtained by obtaining the inter-line angle for each of the combinations of the line segments corresponding to the first line segment 12 and the line segments corresponding to the second line segment 13 and calculating the average of the plurality of inter-line angles obtained as described above.

In the nonwoven fabric 10, a plurality of voids 14 as spatial domains partitioned by the fibers 11 are formed as portions where air is present. In a case where the plurality of voids 14 communicate with each other in the thickness direction Z of the nonwoven fabric 10, pores that penetrate in the thickness direction Z of the nonwoven fabric 10 are formed. For example, in a case where the nonwoven fabric 10 is used as a filter, the pores function as holes of the filter. In addition, in the voids 14, pores are not formed in the thickness direction and are present as, for example, spatial domains closed by the fibers 11.

The void ratio is preferably 90% or more (that is, at least 90%). In addition, the void ratio can increase up to 99%. Therefore, the void ratio is preferably 90% to 99% and more preferably 90% to 95%. By increasing the void ratio, that is, by including a large amount of air in the nonwoven fabric 10, the applications can be widened. For example, higher sound absorbing performance and heat insulating performance are exhibited as compared to a case where the void ratio is less than 90%. Therefore, the nonwoven fabric 10 is used as a sound absorbing material and a heat insulating member. In a case where the nonwoven fabric 10 is used as a filter, higher filtration performance is exhibited as compared to a case where the void ratio is less than 90%. The filtration performance refers to, for example, the throughput per unit time and/or persistence in a state where clogging is suppressed.

The void ratio (the unit is %) can be obtained from [1−{(W/1000)/(H/1000)}ρ/1]×100, where W (the unit is g/m²) representing the basis weight of the nonwoven fabric 10, H (the unit is mm) representing the thickness, and ρ1 (the unit is kg/m³) representing the specific gravity of the fibers 11. As the basis weight W, a value obtained by cutting the nonwoven fabric 10 in 5 cm×5 cm, measuring the mass using an electronic balance (manufactured by Mettler Toledo), and converting the measured value into a value per 1 m² is used. In this example, the thickness H is measured using a non-contact laser displacement meter (LK-H025 manufactured by Keyence Corporation).

In addition, in the nonwoven fabric 10, in the above-described heating and drawing step 22, by drawing the fiber assembly 60, the voids 14 are extended, and the average (hereinafter, referred to as “average pore diameter DA”) of pore diameters of the voids 14 is 15.0 μm or more. This way, by adjusting the average pore diameter DA to be 15.0 μm or more, the applications as the nonwoven fabric 10 can be extended. For example, the nonwoven fabric 10 can be used as a filter for separating cancer cells (diameter of about 15.0 μm to 25.0 μm) from blood.

The average pore diameter DA can be obtained using the following method. First, a sample having a size of 5 square centimeters (5 cm×5 cm) is cut from the nonwoven fabric 10. The average pore diameter DA is obtained by dipping this sample in a GALWICK (manufactured by POROUS MATERIAL) having a surface tension of 15.3 mN/m and measuring the pore diameter with a bubble point method using a perm porometer (manufactured by POROUS MATERIAL).

The average pore diameter DA is preferably in a range of 15.0 μm or more and 40 μm or less and more preferably in a range of 15.0 μm or more and 30 μm or less. In addition, in the nonwoven fabric 10, it is preferable that the average pore diameter DA is 15.0 μm or more and the average fiber diameter DF is 1.0 μm or more. This way, by adjusting the average pore diameter DA to be 15.0 μm or more and adjusting the average fiber diameter DF to be 1.0 μm or more, in a case where the nonwoven fabric 11 is used as a filter, deformation with respect to a pressure of fluid is suppressed and more stable filtration performance is exhibited as compared to a case where the average fiber diameter is less than 1.0 μm. The nonwoven fabric 10 is particularly suitable for use as a biofilter.

Further, in the nonwoven fabric 10, in the above-described heating and drawing step 22, the fibers are drawn in a state where the temperature of the fibers 11 are a melting point Tm of the fibers 11 or higher, that is, in a state where the fibers 11 are sufficiently softened. As a result, a variation in pore diameter is suppressed within a given range. Specifically, a relative standard deviation of a pore diameter distribution of the nonwoven fabric 10 is adjusted to be 0.1 or less. As a result, by adjusting the standard deviation of the pore diameter distribution to be 0.1 or less, in a case where the nonwoven fabric 10 is used as a filter, stable filtration performance is obtained. The standard deviation of the pore diameter distribution is more preferably 0.09 or less and still more preferably 0.08 or less.

The fibers 11 are formed of a resin (polymer) (the material (fiber material) of the fibers 11 is a polymer). Specific examples of the material include a cellulose polymer, a cycloolefin polymer (for example, COP), polymethyl methacrylate, polyester, polyurethane, polyethylene (PE), polypropylene, an elastomer, polylactic acid, polystyrene, polycarbonate, an acrylic resin, polyvinyl alcohol (PVA), gelatin, polyimide, polyether ether ketone (PEEK), a liquid crystalline polymer (LCP), and a fluororesin.

In a case where the material is a cellulose polymer, it is preferable that the cellulose polymer is cellulose acylate. The cellulose acylate is a cellulose ester in which some or all of hydrogen atoms forming a hydroxy group of cellulose are substituted with an acyl group. It is preferable that the cellulose acylate is any one of cellulose acetate propionate (CAP) or cellulose triacetate (TAC). The polymer as the material of the fibers 11 is preferably a polymer that can be dissolved in a solvent to form a solution and more preferably a polymer that can be dissolved in an organic solvent to form a solution.

The nonwoven fabric 10 can be manufactured using a nonwoven fabric manufacturing facility 20 shown in FIG. 2. The nonwoven fabric manufacturing facility 20 is configured with a fiber assembly manufacturing step 21 and the heating and drawing step 22. The fiber assembly manufacturing step 21 is provided to form the fibers 11 and to manufacture the fiber assembly 60 using an electrospinning method.

The fiber assembly manufacturing step 21 includes a solution preparation portion 23 and a fiber assembly manufacturing portion 24. The solution preparation portion 23 prepares a solution 23a for forming the fibers 11. The solution preparation portion 23 dissolves the material (fiber material) of the fibers 11 in a solvent to prepare the solution 23a.

The fiber assembly manufacturing portion 24 includes a nozzle unit 25, a collection portion 26, and a power supply 27. The nozzle unit 25 is formed to be elongated in a width direction (direction perpendicular to the drawing) of the support 30 described below, and a plurality of nozzles 25a are disposed in a longitudinal direction (that is, the width direction of the support 30). The solution 23a prepared by the solution preparation portion 23 is supplied to each of the nozzles 25a, and the solution 23a is discharged from each of the nozzles 25a to the collection portion 26.

The collection portion 26 includes a collector 52, a support supply portion 57, and a support winding portion 58. The collector 52 attracts the solution 23a discharged from the nozzles 25a, and collects the formed fibers 11 to form the fiber assembly 60. In the embodiment, the fibers 11 are collected on the support 30 described below. The collector 52 is configured with an endless belt that is formed of a metal strip in a cyclic shape, is stretched by rollers 61 and 62, and is circulated by the rotation of the rollers 61 and 62.

The power supply 27 applies a voltage between the collector 52 and the nozzle unit 25 (the nozzles 25a). As a result, one of the collector 52 or the nozzles 25a is positively (+) charged, and another one of the collector 52 or the nozzles 25a is negatively charged. As a result, the solution 23a is attracted to the collector 52 side, and is blown from the nozzles 25a to the collector 52. The collector 52 may be formed of a material that is charged by being applied with a voltage from the power supply 27 and, for example, is formed of stainless steel.

The support supply portion 57 supplies, for example, the support 30 formed of a strip-shaped aluminum sheet to the collector 52. The support 30 moves along the movement of the collector 52 and passes through a region below the nozzle unit 25. During this time, the fibers 11 blown from the nozzles 25a are sequentially collected on the support 30 to form the strip-shaped fiber assembly 60. Next, the support 30 is removed from the fiber assembly 60, and the support 30 is wound around the support winding portion 58. On the other hand, the fiber assembly 60 is transported to the heating and drawing step 22.

The fibers 11 may be configured to be collected without passing through the support 30 may be configured such that the fiber assembly 60 is directly formed on the collector 52 without passing through the support 30). In addition, in the description of the example, the fibers 11 (fiber assembly 60) are formed using an electrospinning method. However, the fibers 11 (fiber assembly 60) may formed using a solution spinning method (method in which the fibers 11 are formed by causing the solution 23a to fall from the nozzles 25a to the collector 52 due to its own weight irrespective of a potential difference.

The heating and drawing step 22 includes a tenter 70 and a heating chamber 71. The tenter 70 includes a support member 70a that supports both side portions of the fiber assembly 60 in the width direction, and transports the fiber assembly 60 to pass through the heating chamber 71 while both side portions of the fiber assembly 60 are being supported by the support member 70a. The support member 70a may be a type of gripping the fiber assembly 60 with an openable clip or may be a type in which an acicular member is pierced into the fiber assembly 60 to support the fiber assembly 60.

The heating chamber 71 includes a heater 72, in which the fiber assembly 60 is heated by the heater 72 to reach the melting point Tm of the fibers 11. A method of heating the fiber assembly 60 can be freely set. Therefore, for example, the fiber assembly 60 may be heated by directly applying heat from the heater 72 to the fiber assembly 60, or the fiber assembly 60 may be heated by blowing heat from the heater 72 to the fiber assembly 60 using a blower, that is, blowing hot air to the fiber assembly 60. Due to this heating, the fiber assembly 60 is softened and contracted to obtain the nonwoven fabric 10 (the nonwoven fabric 10 is manufactured). In addition, due to this heating, a residual stress is removed from the fiber assembly 60, and the fibers 11 are linearized. As the fibers 11 are linearized, the pore diameter uniformity of the fibers 11 can be improved, and the relative standard deviation of the pore diameter distribution can be suppressed to be low.

The tenter 70 adjusts a gap between the support member 70a that supports one side portion of the fiber assembly 60 and the support member 70a that supports another side portion of the fiber assembly 60 to extend toward the downstream side (right side in FIG. 2) in the transport direction. As a result, the fiber assembly 60 is extended in width (drawn) toward the downstream side in the transport direction. This way, by extending the diameter of the fiber assembly 60 while heating the fiber assembly 60, the linearity of the fibers 11 in the width direction can be more reliably improved. In addition, the pore diameter can be adjusted (the pore diameter can be increased to a desired value). In the embodiment, the fiber assembly 60 is extended in diameter such that the pore diameter is 15.0 μm or more. The extension in width (drawing) is performed preferably in a draw ratio range of 200% or less and more preferably in a draw ratio range of 170% or less with respect to the width of the fiber assembly 60. As a result, breakage of the nonwoven fabric can be suppressed.

However, in the heating and drawing step 22, depending on a temperature history (a relationship between a temperature and a time) and a timing of the extension in width, there may be a case where excellent nonwoven fabric cannot be manufactured. For example, in a case where the temperature of the fibers 11 reaches the melting point Tm within a short period of time, a residual stress cannot be completely removed, the pore diameter cannot be sufficiently made to be uniform, and the value of the relative standard deviation of the pore diameter distribution increases. In addition, during heating or during cooling after heating, the temperature of the fibers 11 is lower than the melting point Tm, and in a case where the extension in width is performed in a state where the fibers 11 are not sufficiently softened, a force for the extension in width is not uniformly applied to the entire area of the fiber assembly 60 due to a thickness unevenness of the fiber assembly 60, the amount of the extension in width varies depending on portions, the pore diameter cannot be sufficiently made to be uniform, and the value of the relative standard deviation of the pore diameter distribution increases.

Therefore, in the heating and drawing step 22, the fiber assembly 60 is heated such that a heating required time (hereinafter, also referred to as “heating time”) taken until the temperature of the fibers 11 reaches the melting point Tm after reaching 90% of the melting point Tm (in a case where the melting point Tm is 100° C., 90° C.) is 15 seconds or longer (that is, at least 15 seconds) and 500 seconds or shorter. The heating required time is preferably 15 seconds to 180 seconds. As a result, while suppressing filming (a phenomenon in which the fibers 11 are dissolved to block pores (voids)), a residual stress can be reliably removed, and the pore diameter can be made to be uniform. The heating temperature is preferably in a range of Tm or higher and Tm+10° C. or lower and more preferably in a range of Tm or higher and Tm+5° C. or lower.

In the heating and drawing step 22, it is preferable that the fiber assembly 60 is cooled (may be natural cooling or forced cooling) after the temperature of the fibers 11 reaches the melting point Tm. In addition, during the cooling, a cooling required time (hereinafter, also referred to as “cooling time”) taken until the temperature of the fibers 11 reaches 90% of the melting point Tm after reaching the melting point Tm is preferably 15 seconds or longer (that is, at least 15 seconds) and 500 seconds or shorter. The cooling required time is more preferably 15 seconds to 180 seconds and still more preferably 15 seconds to 60 seconds. As a result, a residual stress can be reliably removed while maintaining productivity.

On the other hand, as described above, in a case where the heating time and/or the cooling time is excessively long, that is, in a case where a time for which the heating time and/or the cooling time is 90% or more of the melting point Tm, there is a problem in that the fiber assembly 60 is filmed. Therefore, in the heating and drawing step 22, the thickness of the fiber assembly 60 (nonwoven fabric 10) after heating is maintained at a thickness that is preferably 50% or more (that is, at least 50%) and more preferably 80% or more of the thickness of the fiber assembly 60 before heating. In other words, it is preferable that the fiber assembly 60 is heated such that the thickness of the fiber assembly 60 can be maintained at a thickness that is preferably 50% or more and more preferably 80% or more. As a result, the filming of the fiber assembly 60 can be prevented.

Further, in the heating and drawing step 22, the extension in width is performed in a state where the temperature of the fibers 11 (fiber assembly 60) reaches the melting point Tm and the fibers 11 are sufficiently softened. More specifically, the extension in width is performed in a state where the temperature of the fibers 11 is the melting point Tm or higher. This way, in a case where the extension in width is performed in a state where the temperature of the fibers 11 is the melting point Tm or higher and the fibers 11 are sufficiently softened, a force for the extension in width can be uniformly applied to the entire area of the fiber assembly 60, and the relative standard deviation of the pore diameter distribution can be suppressed to be small, more specifically, 0.1 or less.

The extension in width only has be performed in a state where the temperature of the fibers 11 is the melting point Tm or higher. Therefore, for example, a tension may be applied to the fiber assembly 60 in a width extension direction before the temperature of the fibers 11 reaches the melting point Tm, and the fibers 11 may be softened after the temperature of the fibers 11 is the melting point Tm or higher such that the extension in width is performed due to the action of the applied tension. Here, as described above, the fiber assembly 60 is heated to be softened and contracted. Therefore, in the heating and drawing step 22, the tension (drawing force) that is applied to the fiber assembly 60 is set to be a size such that the fiber assembly 60 can be extended in width against the force to contract the fibers 11. Specifically, in a case where the fiber diameter is 2 μm and the basis weight is 17 g/m², the tension is in a range of 3 N/m or more and 20 N/m or less.

Of course, the present invention is not limited to the configuration in which the tension (drawing force) is applied before the temperature of the fibers 11 reaches the melting point Tm. The tension may be applied after the temperature of the fibers 11 reaches the melting point Tm to perform the extension in width (drawing) without being applied until the temperature of the fibers 11 reaches the melting point Tm. In addition, in the embodiment, the example in which the drawing is the extension in width, that is, the example in which the tension (drawing force) is applied to the fiber assembly 60 in the width direction such that the fiber assembly 60 is drawn (extended in width) in the width direction is described. However, the present invention is not limited to this example. The tension (drawing force) may be applied to the fiber assembly 60 in the transport direction (longitudinal direction) such that the fiber assembly 60 is drawn in the transport direction.

Hereinafter, the verification results for verifying the effects of the present invention will be described. In the verification, in Examples 1 to 7 where the fibers were heated to the melting point Tm or higher to be drawn using the nonwoven fabric manufacturing facility 20 or the like shown in FIG. 2 and Comparative Example 1 where the nonwoven fabric manufacturing facility according to the embodiment of the present invention was not used and fibers were not heated to the melting point Tm or higher to be drawn, eight kinds of nonwoven fabrics were manufactured, respectively, and the performances thereof were evaluated. The details of the manufacturing methods and the nonwoven fabric obtained using each of the manufacturing methods are as shown in Table 1. In addition, the evaluation is as shown in Table 2. In the evaluation, a case where the nonwoven fabric was excellent as a product was evaluated as “A”, a case where the nonwoven fabric was substantially excellent as a product was evaluated as “B”, and a case where the nonwoven fabric had a problem to be solved was evaluated as “C”.

TABLE 1

| | Nonwoven Fabric | | | | | | | | |
|---|---|---|---|---|---|---|---|---|---|
| | | | | | Relative | | | | |
| | | Average | Average | | Standard | Manufacturing Method | | | |
| | | Fiber | Pore | Basis | Deviation of | | Heating | Drawing | Draw |
| | | Diameter | Diameter | Weight | Pore Diameter | | Temperature | Force | Ratio |
| | Material | (μm) | (μm) | (g/m²) | Distribution | Spinning Method | (° C.) | (N/m) | (%) |
| Example 1 | CAP | 2.00 | 15.0 | 17.0 | 0.08 | Electrospinning | Tm or Higher | 10 | 150 |
| Example 2 | PU | 2.00 | 15.0 | 17.0 | 0.10 | Electrospinning | Tm or Higher | 10 | 150 |
| Example 3 | CAP | 3.00 | 20.0 | 17.0 | 0.10 | Electrospinning | Tm or Higher | 10 | 150 |
| Example 4 | CAP | 2.00 | 15.0 | 17.0 | 0.10 | Solution Spinning | Tm or Higher | 10 | 150 |
| Example 5 | CAP | 3.00 | 25.0 | 17.0 | 0.10 | Electrospinning | Tm or Higher | 10 | 150 |
| Example 6 | CAP | 3.00 | 15.0 | 17.0 | 0.10 | Electrospinning | Tm or Higher | 10 | 120 |
| Example 7 | CAP | 3.00 | 30.0 | 17.0 | 0.10 | Electrospinning | Tm or Higher | 10 | 200 |
| Comparative | PE | 5.00 | 20.0 | 17.0 | 0.20 | Solution Spinning | Tm or Lower | Not | Not |
| Example 1 | | | | | | | | Drawn | Drawn |

TABLE 2

| | Evaluation | | | | |
|---|---|---|---|---|---|
| | Separation | | | | |
| | Performance | Biocompat- | | Surface | Working |
| | of Filter | ibility | Strength | Shape | Suitability |
| Example 1 | A | A | A | A | A |
| Example 2 | B | B | A | A | A |
| Example 3 | B | A | A | A | A |
| Example 4 | B | A | A | A | A |
| Example 5 | B | A | A | A | A |
| Example 6 | B | A | A | A | A |
| Example 7 | B | A | A | B | A |
| Comparative | C | C | C | A | C |
| Example 1 | | | | | |

In Table 1, it was able to be verified that, in Examples 1 to 7, the average fiber diameter was 3.00 μm or less, the average pore diameter was 15 μm or more, the relative standard deviation of the pore diameter distribution was 0.1 or less, and nonwoven fabric having excellent performance was obtained. In addition, it was able to be verified in Table 2 that, in Examples 1 to 7, the evaluation results relating to the separation performance of the filters, the biocompatibility, the strength, the surface shape, and the working suitability were also excellent (the evaluation results were B or higher) and nonwoven fabric having excellent performance was obtained.

This way, nonwoven fabric having excellent performance can be obtained by drawing the fibers in a state where the fibers are heated to the melting point Tm or higher. On the other hand, in Comparative Example 1 where the fibers were not drawn, the average fiber diameter was larger than that of Examples (3.00 μm or more), the relative standard deviation of the pore diameter distribution was larger than that of Examples (0.1 or more), and it is difficult to say that the evaluation results were excellent. As a result, it was able to be verified that the drawing in a state where the fibers are heated to the melting point Tm or higher contributes to the improvement of the performance of the nonwoven fabric.

### EXPLANATION OF REFERENCES

10: nonwoven fabric

10A: first surface

11: fiber

11A: first fiber

11B: second fiber

12: first line segment

12a, 12b: contact

13: second line segment

13a, 13b: contact

14: void

20: nonwoven fabric manufacturing facility

21: fiber assembly manufacturing step

22: heating and drawing step

23: solution preparation portion

23a: solution

24: fiber assembly manufacturing portion

25: nozzle unit

25a: nozzle

26: collection portion

27: power supply

30: support

52: collector

57: support supply portion

58: support winding portion

60: fiber assembly

61, 62: roller

70: tenter

70a: support member

71: heating chamber

72: heater

D1: fiber diameter

DF: average fiber diameter

DA: average pore diameter

Tm: melting point

What is claimed is:

1. Nonwoven fabric that is formed of fibers,
wherein an average pore diameter is 15 μm or more,
a relative standard deviation of a pore diameter distribution is 0.1 or less, and
an average fiber diameter of the fibers is 3 μm or less.

2. The nonwoven fabric according to claim 1,
wherein the fibers are formed of a cellulose polymer.

3. A nonwoven fabric manufacturing method in which nonwoven fabric is formed by blowing a solution in which a fiber material is dissolved in a solvent to a collector to form fibers and collecting the blown fibers, the nonwoven fabric manufacturing method comprising:
a heating and drawing step of heating and drawing a fiber assembly formed by collecting the fibers,
wherein in the heating and drawing step, the fibers are drawn in a state where a temperature of the fibers is a melting point or higher.

4. The nonwoven fabric manufacturing method according to claim 3,
wherein a tension is applied to the fiber assembly before the temperature of the fibers reaches the melting point, and the fiber assembly is drawn by the tension after the temperature of the fibers reaches the melting point.

5. The nonwoven fabric manufacturing method according to claim 3,
wherein the fibers are blown by applying a voltage between the solution and the collector.

6. The nonwoven fabric manufacturing method according to claim 4,
wherein the fibers are blown by applying a voltage between the solution and the collector.

7. The nonwoven fabric manufacturing method according to claim 3,
wherein the fibers are formed of a cellulose polymer.

8. The nonwoven fabric manufacturing method according to claim 4,
wherein the fibers are formed of a cellulose polymer.

9. The nonwoven fabric manufacturing method according to claim 5,
wherein the fibers are formed of a cellulose polymer.

10. The nonwoven fabric manufacturing method according to claim 6,
wherein the fibers are formed of a cellulose polymer.
